(19) United States
(12) Patent Application Publication
(10) Pub. No.: US 2008/0269098 A1
(43) Pub. Date: Oct. 30, 2008

(54) Liquid Composition

(75) Inventor: Daniele Fregonese, Novara (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/573,695

(22) PCT Filed: Jul. 22, 2005
(86) PCT No.: PCT/GB2005/002870

§ 371 Date: Apr. 27, 2007

(30) Foreign Application Priority Data
Aug. 20, 2004 (GB) 0418625.0

(51) Int. Cl. C11D 3/395

(52) U.S. Cl. 510/221; 510/407; 510/372

(57) ABSTRACT

A multi-chamber bottle comprises in one chamber a bleaching composition and in another chamber a bleach sensitive formulation. The viscosity of the bleaching composition is controlled by an admixture of a thickener and a hydrocarbon. The density of the bleaching composition is controlled by the presence of an ionic salt.

The present invention relates to a liquid detergent composition.

Detergent compositions are well known. Typical detergent compositions include a source of active oxygen. For example, peroxygen compounds are often included in detergent compositions to improve their stain-removing properties.

Peroxygen compounds, however, are relatively unstable and tend to decompose on storage. Thus, bleaching compositions containing such compounds tend to lose their bleaching power during storage. Additionally bleaching compositions are usually quite aggressive to other more sensitive components of a detergent formulation (e.g. enzymes) and need to be kept separate therefrom

Separation in solid formulations is straightforward and may be achieved by the use of multi-phase solids such as multi layer tablets wherein one layer contains a bleach and another layer contains a bleach sensitive component such as an enzyme.

Separation in liquids is more difficult. One way to achieve this separation is by the use of a multi-chamber bottle with one chamber of the bottle containing a bleaching formulation and another chamber containing a bleach sensitive formulation.

However, a recognised problem with the use of multi-chamber bottles is the difficulty that can be experienced trying to achieve equal/appropriate discharge of each of the chambers so that the right amount of composition from each chamber is dispensed into the washing machine.

It is an object of the present invention to obviate/mitigate the problems outlined above.

According to the present invention, there is provided a multi-chamber bottle comprising in one chamber a bleaching composition and in another chamber a bleach sensitive formulation, the viscosity of the bleaching composition being controlled by an admixture of a thickener and a hydrocarbon, and the density of the bleaching composition being controlled by the presence of an ionic salt.

Surprisingly it has been found that by using the viscosity and density controlling agents above, equal/appropriate release of each of the formulations may be achieved over time (i.e. over prolonged storage/transportation) and throughout the use of the bottle. Without wishing to be bound by theory it is proposed that the even discharge of the two formulations from the bottle of the present invention arises from a firm control of their relative pourability (a function of viscosity (η) and density (δ)).

Also the viscosity of the contents of the bleaching formulation containing chamber has been found to remain constant even with prolonged storage.

Generally the bleaching composition comprises phthalimidoperhexanoic acid (PAP) as the bleaching component (e.g. as available from Solvay Solexis).

Usually the PAP is supplied as a stable water suspension at, for example, a concentration of 17%. Usually the PAP suspension comprises from 10-50% of the bleaching composition, more preferably from 20-40% and most preferably about 30%.

The PAP preferably has a particle size of about 50 μm.

Preferably the hydrocarbon component of the bleaching composition comprises paraffin (C₁₅-C₂₄).

Generally the paraffin content of the bleaching composition is about 2%.

Preferably the thickener of the bleaching composition is cellulose based, e.g. a xanthan gum (e.g. as available from Monsanto, US or ADM US).

Generally the xanthan gum content of the bleaching composition is about 0.5%.

Preferably the ionic salt present in the bleaching composition is present in an amount of from 3-35%, more preferably from 5 to 20% and most preferably about 10%.

Most preferably the ionic salt is sodium sulphate.

Generally the contents of the multi-chamber bottle are intended to be used as a detergent in an automatic washing machine, e.g. an automatic dishwasher. As such the combined composition formed by combining the contents of the chambers of the bottle generally comprises an automatic dishwasher detergent formulation

Accordingly the detergent most preferably comprises an automatic dishwasher detergent. Examples of which include conventional detergents, and the ‘2-in-1’ and ‘3-in-1’ variants.

The detergent formulation typically comprises one or more of the following components; builder, co-builder, surfactant, bleach activator, bleach catalyst, enzyme, polymer, dye, pigment, fragrance, water and organic solvent.

Of these components it will be appreciated that some (e.g. fragrance and enzyme may be bleach sensitive) and thus may be confined to the bleach sensitive chamber of the bottle.

Being intended to be placed in a bottle the composition are most preferably liquid. The liquid compositions are preferably aqueous.

Generally the bottle is twin-chambered.

The invention will now be described with reference to the following non-limiting examples.

### EXAMPLE 1

The following bleach containing and bleach sensitive compositions were prepared.

| | |
|---|---|
| Component | % w/w |

Bleach Containing

| | |
|---|---|
| Water | 54.5 |
| PAP mixture (17% active PAP) | 33.0 |
| Xanthan Gum | 0.54 |
| Paraffin | 2.0 |
| Sodium Sulphate | 10.0 |

Bleach Sensitive

| | |
|---|---|
| Water | 36.5 |
| H₂SO₄ (25%) | 0.1 |
| KTTP | 35.0 |
| Perfume | 0.3 |
| Sulphonated polymer | 2.0-4.0 |
| NaTTP | 13.0 |
| Protease | 1.1 |
| Amylase | 0.32 |
| Polyacrylic Acid | 0.85 |
| Sorbitol | 11.0 |
| Preservative, dye | 0.002-0.1 |

The bleaching composition was stored (storage conditions set out in the table below) and its viscosity was measured after time. The results are in the table below

| Storage | Viscosity | | |
|---|---|---|---|
| Conditions | After 0 weeks | After 1 week | After 2 weeks |
| 25° C./50% RH | 11200 | 14100 | 13700 |
| 30° C./70% RH | 11200 | 14900 | 13800 |
| 40° C./75% RH | 11200 | 14600 | 12300 |
| 50° C. | 11200 | 14200 | — |

The viscosity of a comparative composition (without paraffin oil) was also measured.

The results are in the table below.

| Storage | Viscosity | | |
|---|---|---|---|
| Conditions | After 0 weeks | After 1 week | After 2 weeks |
| 25° C./50% RH | 11500 | 19000 | 17100 |
| 30° C./70% RH | 11500 | 18700 | 18300 |
| 40° C./75% RH | 11500 | 18800 | 18000 |
| 50° C. | 11500 | 16400 | — |

2% of paraffin oil in the bleach formulation is enough to keep the viscosity within a very narrow range.

1. A multi-chamber bottle comprising in one chamber a bleaching composition and in another chamber a bleach sensitive formulation, the viscosity of the bleaching composition being controlled by an admixture of thickener and a hydrocarbon, and the density of the bleaching composition being controlled by the presence of an ionic salt.

2. A bottle according to claim 1, wherein the bleaching composition comprises phthalimidoperhexanoic acid (PAP) as the bleaching component.

3. A bottle as in claim 2, wherein the PAP comprises about 30% of the bleaching composition.

4. A bottle according to claim 1, wherein the hydrocarbon component of the bleaching composition comprises paraffin.

5. A bottle according to claim 4, wherein the paraffin content of the bleaching composition is about 2%.

6. A bottle according to claim 1 wherein the thickener of the bleaching composition is cellulose based gum.

7. A bottle according to claim 6, wherein the cellulose based gum is xanthan gum.

8. A bottle according to claim 7, wherein the ionic salt present in the bleaching composition is present in an amount of about 10%.

9. A bottle according to claim 8, wherein the ionic salt is sodium sulphate.

10. A bottle according to claim 1 wherein the bleach containing composition and/or the bleach sensitive composition includes a hydrophobic component having a density of 0.6-1 gram/cm³.

11. A bottle according to claim 10, wherein the viscosity of the hydrophobic component is less than 300 cp.

12. A bottle according to claim 10, wherein the hydrophobic component is a hydrocarbon oil, an edible oil, or a mixture thereof.

13. A bottle according to claim 12 wherein the oil is olive oil, sunflower oil, maize oil, rape oil, soya oil, peanut oil, meadowfoam seed oil, linseed oil, walnut oil, sesame oil, thistle oil or a mixture thereof.

14. A bottle according to claim 13, wherein the hydrophobic component is a paraffin oil.

15. An automatic dishwashing process which comprises the step of:
dispensing the bleach containing composition and the bleach sensitive composition from a bottle according to claim 1 during an automatic dishwashing process.

16. A bottle according to claim 10 wherein the bleach containing composition and/or the bleach sensitive composition includes a hydrophobic component having a density of 0.7-0.92 grams cm³.

17. A bottle according to claim 16 wherein the bleach containing composition and/or the bleach sensitive composition includes a hydrophobic component having a density of 0.75-0.92 grams cm³.

18. A bottle according to claim 17 wherein the bleach containing composition and/or the bleach sensitive composition includes a hydrophobic component having a density of 0.8-0.92 grams cm³.

19. A bottle according to claim 11, wherein the viscosity of the hydrophobic component is between 50-250 cp.

20. A bottle according to claim 19, wherein the viscosity of the hydrophobic component is between 75 to 150 cp.
